(19) United States
(12) Patent Application Publication
(10) Pub. No.: US 2025/0015603 A1
(43) Pub. Date: Jan. 9, 2025

(54) DEVICE POWER SUPPLY METHOD AND APPARATUS, TERMINAL DEVICE AND STORAGE MEDIUM

(71) Applicant: PAX COMPUTER TECHNOLOGY (SHENZHEN) CO., LTD., Shenzhen (CN)

(72) Inventor: CHUAN LIU, Shenzhen (CN)

(21) Appl. No.: 18/687,379

(22) PCT Filed: Jul. 11, 2022
(86) PCT No.: PCT/CN2022/104790

§ 371 Date: Sep. 25, 2024

(30) Foreign Application Priority Data
Sep. 6, 2021 (CN) 202111037940.4

(51) Int. Cl. H02J 7/00

(52) U.S. Cl. CPC H02J 7/00034; H02J 7/0029; H02J 2207/40

(57) ABSTRACT

The present application provides a device power supply method and apparatus, a terminal device and a storage medium, and relates to the technical field of device power supply. The device power supply method comprises: obtaining historical power supply data of a target device, wherein the historical power supply data comprises at least two power supply data sets, and sampling times of power supply data contained in any two power supply data sets are not exactly the same; selecting a target power supply data set from the at least two power supply data sets on the basis of data statistical parameters respectively corresponding to the at least two power supply data sets; determining a power supply mode of the target device according to the target power supply data set; and using the power supply mode to power the target device. The device of the present application can be safely powered.

The present application claims the benefit of and priority to Chinese patent application NO. 202111037940.4, field on Sep. 6, 2021, the entirety of which is incorporated herein by reference.

### FIELD

The present disclosure relates to the technical field of device power supply, and in particular relates to a device power supply method and apparatus, a terminal device and a storage medium.

### BACKGROUND

As the application of terminal device becomes more and more widespread, the application of batteries in the terminal device also becomes more and more widespread. For example, lithium batteries are widely used in various industries due to their advantages of high energy density, high open-circuit voltage, low discharge, wide operating temperature range, and low price, and the scenarios include electric vehicles, cell phones, and POS terminals.

However, it is possible for the batteries to explode when used inappropriately. For example, a user connects an adapter to a terminal device for a long period of time to charge the battery of the terminal device, this will leave the battery in a state of high voltage/charge for a long period of time, which may lead to an explosion or bulging of the battery.

Therefore, there is an urgent need to provide a method that can effectively reduce the security risk of power supply to the terminal device.

### Technical Problem

The embodiment of the present application provides a device power supply method and apparatus, a terminal device and a storage medium to solve the problem of increasing the security risk of power supply of the terminal device due to different usage habits of users of the terminal device.

### Technical Solution

In a first aspect, the embodiments of the present application provide a device power supply method, including:
obtaining historical power supply data of a target device, wherein the historical power supply data comprises at least two power supply data sets, and sampling times of power supply data included in any two power supply data sets are not exactly the same;
selecting a target power supply data set from the at least two power supply data sets on the basis of data statistical parameters respectively corresponding to the at least two power supply data sets;
determining a power supply mode of the target device according to the target power supply data set;
using the determined power supply mode to power the target device.

The device power supply method provided in the present application obtains at least two power supply data sets of the target device, so as to understand the user's usage of the target device at different sampling times through the at least two power supply data sets, then select a target power supply data set from the at least two power supply data sets on the basis of data statistical parameters respectively corresponding to the at least two power supply data sets, to determine the power supply mode of the target device based on the target power supply dataset that can better reflect the user's habits of using the target device, thereby avoiding long-term use of the same power supply mode to power the target device, reducing the power supply safety risk of the target device.

In a second aspect, the embodiments of the present application provide a device power supply apparatus, including:
an acquisition module configured for obtaining historical power supply data of a target device, wherein the historical power supply data comprises at least two power supply data sets, and sampling times of power supply data included in any two power supply data sets are not exactly the same;
a selection module configured for selecting a target power supply data set from the at least two power supply data sets on the basis of data statistical parameters respectively corresponding to the at least two power supply data sets;
a determination module configured for determining a power supply mode of the target device according to the target power supply data set;
a power supply module configured for using the determined power supply mode to power the target device.

In a third aspect, the embodiments of the present application provide a terminal device, the terminal device includes a storage, a processor, and computer program stored in the storage and runnable on the processor, when the processor executes the computer program, the terminal device is enabled to implement the device power supply method.

In a fourth aspect, the embodiments of the present application provide a computer readable storage medium, the computer readable storage medium stores computer program, the computer program is executed by a processor and configured to implement the device power supply method.

In a fifth aspect, the embodiments of the present application provide a computer program product, when the computer program product runs on a terminal device, the terminal device is enabled to execute any of the device power supply methods described in the first aspect.

It can be understood that the beneficial effects of the second aspect to the fifth aspect mentioned above can be found in the relevant description of the first aspect and will not be further elaborated here.

### BRIEF DESCRIPTION OF THE DRAWINGS

In order to more clearly illustrate the technical solutions in the embodiment of the present application, the following will briefly introduce the accompanying drawings that need to be used in the description of the embodiment or prior art, and it will be obvious that the accompanying drawings in the following description are only some of the embodiment of the present application, and for the person of ordinary skill in the field, other accompanying drawings can be obtained according to these drawings without paying the creative laboriousness.

FIG. 1 is a flowchart of a device power supply method according to an embodiment of the present disclosure.

FIG. 2 is a specific implementation flowchart of step S12 of the device power supply method according to an embodiment of the present disclosure.

FIG. 3 is a specific implementation flowchart of step S13 of the device power supply method according to an embodiment of the present disclosure.

FIG. 4 is a schematic diagram of a device power supply apparatus according to an embodiment of the present disclosure.

FIG. 5 is a schematic diagram of a terminal device according to an embodiment of the present disclosure.

### DETAILED DESCRIPTION OF THE INVENTION

In the following description, specific details such as particular system structures, techniques, and the like are presented for purposes of illustration and not for purposes of limitation, for a thorough understanding of the embodiments of this application. The person of ordinary skill in the field should understand that the present application can also be implemented in other embodiments without these specific details.

As used in the present application specification and the accompanying claims, the term “if” may be interpreted in context as “when” or “once” or “in response to determination” or “in response to detection”. Similarly, the phrases “if determined” or “if [the described condition or event] is detected” may be interpreted, depending on the context, to mean “once determined” or “in response to a determination” or “once [the described condition or event] is detected” or “in response to the detection of [the described condition or event]”.

Furthermore, in the description of the present application and the accompanying claims, the terms “first”, “second”, “third”, etc. are only used to distinguish the description and cannot be understood as indicating or implying relative importance.

Refer to “one embodiment” or “some embodiments” etc. described in the specification of the present application imply that one or more embodiments of the present application include a particular feature, structure or characteristic described in conjunction with that embodiment. Therefore, the phrases “in one embodiment”, “in some embodiments”, “in some other embodiments”, “in some other embodiments”, etc., which appear in different places in the present specification, do not necessarily refer to the same embodiment, but rather imply “one or more, but not all, embodiments”, unless otherwise specifically emphasized. The terms “including”, “comprising”, “having” and variations thereof imply “including but not limited to” unless otherwise specifically emphasized.

In order to illustrate the technical solutions of the present application, the following is by way of specific embodiments.

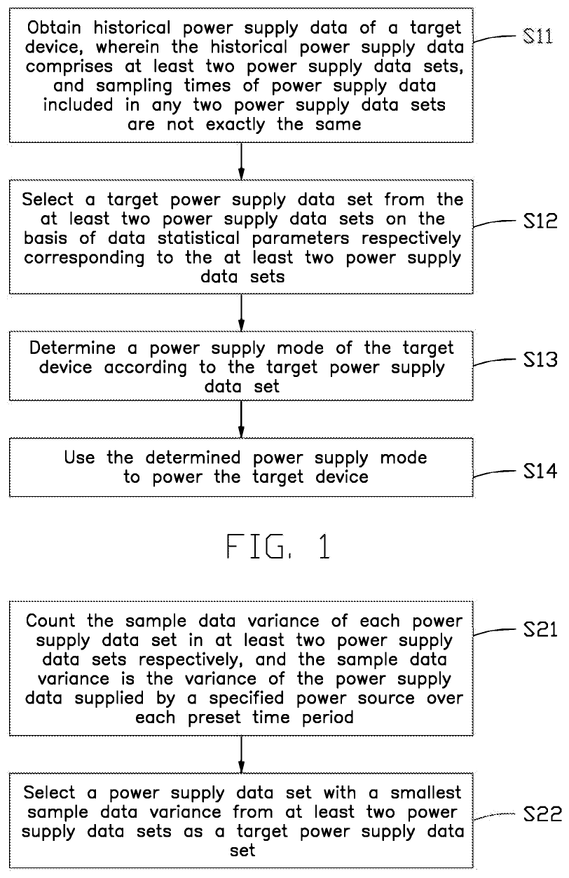

Referring to FIG. 1, FIG. 1 is a flowchart of a device power supply method according to one embodiment of the present disclosure. In the embodiment, the device power supply method is used to control the power supply mode of the device in the process of using the device, and its execution subject is the terminal device.

The device power supply method provided by the embodiments of the present application can be applied to terminal devices such as cell phones, tablet computers, wearable devices, in-vehicle devices, augmented reality (AR) devices, notebook computers, ultra-mobile personal computers (UMPC), netbooks, personal digital assistants (PDA), point of sale (POS) machines, and the embodiment of the present application do not limit the specific types of the terminal device.

As shown in FIG. 1, the device power supply method provided by the embodiments of the present application can include the following steps S11-S14.

At step S11, obtain historical power supply data of a target device, wherein the historical power supply data comprises at least two power supply data sets, and sampling times of power supply data contained in any two power supply data sets are not exactly the same.

As an example of the present application, a target device refers to a terminal device that needs to be monitored for charging. For example, a cell phone or a POS machine with a battery used by a user.

The power supply data refers to the data samples obtained from the power supply situation of the target device during its use. For example, if the target device is a POS machine, during the use of the POS machine, the power supply mode of the POS machine is collected every seconds, and the power supply mode is used as the power supply data of the POS machine for that 10 seconds.

Sampling time refers to the time point corresponding to the collected power supply data during the use of the target device. For example, during the use of the POS machine on Dec. 3, 2020, the time corresponding to the collected power supply data is Thursday.

In this embodiment, in order to understand the use of the target device, data that can be used to characterize the power supply of the target device will be recorded when the target device is in an operating state, which will result in the formation of the historical power supply data of the target device, in order to describe the user's habits when using the target device based on its historical power supply data. Therefore, in order to determine which power supply mode the target device should adopt at the current moment, it is necessary to understand the historical power supply data that can describe the user's habits of using the target device in the past duration. In order to obtain data that can better describe the user's habits of using the target device, the historical power supply data of the target device obtained includes at least two power supply data sets, and sampling times of power supply data contained in any two power supply data sets are not exactly the same. The purpose is to reflect the user's habit of using the target device from different perspectives by the power supply data contained in at least two power supply data sets whose sampling times are not exactly the same, thereby providing a data basis for selecting a target power supply data set from the at least two power supply data sets and determining a power supply mode of the target device for an application scenario that is different from that of the current moment by means of the target power supply data set.

Exemplary, the POS machine was used on the day of Dec. 3, 2020, and the power supply data was collected from 10:00 to 11:00 a.m., and it was learned from that the power supply data that the user kept the adapter connected to the POS machine during that period, i.e., the POS machine was powered by a non-battery power supply during that period.

It will be appreciated that in the application, the collected historical power supply data may be obtained from a storage area of the target device, or the historical power supply data of the target device may be obtained from other devices connected to the target device.

In some embodiments, the historical power supply data of the target device is obtained according to a preset acquisition strategy.

In the embodiment, the preset acquisition strategy refers to a method of obtaining the historical power supply data corresponding to the current time of the target device from a database recording the historical power supply of the target device.

Exemplary, the current moment is 15:00 p.m. on Dec. 3, 2020, the historical power supply data is obtained after 15:00 p.m. every day for the past seven consecutive days. Alternatively, the historical power supply data is obtained for every Thursday after 15:00 p.m. for the past four weeks.

In some embodiments, in order to avoid frequently switching the power supply mode of the target device, the historical power supply data of the target device is obtained at a preset acquisition cycle.

In the embodiment, the acquisition cycle can be pre-set according to actual needs.

Exemplary, every 30 minutes, the historical power supply data for the target device is obtained.

As one implementation of the present application, the specific implementation of obtaining historical power supply data of the target device includes:
obtain a first set of power supply data and a second set of power supply data of the target device, the first set of power supply data contains the historical power supply data of the target device for a first duration before the time of the current day, the second set of power supply data contains the historical power supply data of the target device for each week X in a second duration before the time of the current day, and the time of the day is a week X, and X is any of the values from 1 to 7.

In the embodiment, the first duration can be set according to actual needs. For example, the historical power supply data of the target device for 7 consecutive days before the time of the current day.

The second duration can be set according to actual needs. For example, the target device is 28 consecutive days before the time of the current day.

It can be understood that the first duration may be greater than the second duration, may be less than the second duration, or may be equal to the second duration.

In the embodiment, in order to obtain the information that reflects the user's habit of using the target device from different perspectives, obtain the first power supply data set that includes the historical power supply data of the target device for the first duration before the time of the current day, and obtain the second power supply data set that includes the historical power supply data of the target device of each week X in the second duration before the time of the current day.

In some embodiments, since the historical power supply data of the target device is obtained to predict the power supply mode of the target device in the next application scenario, therefore, before obtaining the historical power supply data of the target device, the remaining standby time of the target device is determined. Based on the remaining standby time of the target device, obtain the historical power supply data of the target device within the same duration as the remaining standby time after the past time point corresponding to the current time point.

The remaining standby time refers to the time that the battery power of the target device can support the target device to continue running.

In some embodiments, in order to better power the target device, the remaining standby time is half of the time that the battery power of the target device can support the target device to continue running.

For example, if the battery of the target device is fully charged, it can standby for 10 hours, and the remaining standby time is 5 hours.

At step S12, select a target power supply data set from the at least two power supply data sets on the basis of data statistical parameters respectively corresponding to the at least two power supply data sets.

As an example of the present application, since the data statistical parameters are statistically obtained based on the power supply data contained in the power supply data set, each power supply data set may reflect the user's habit of using the target device through the corresponding data statistical parameters. Therefore, in order to be able to obtain the power supply data that can better describe the user's habit of using the target device, a target power supply data set is selected from the at least two power supply data sets on the basis of the data statistical parameters respectively corresponding to the at least two power supply data sets.

In some embodiments, the data statistical parameters may be any one of sample data variance, sample data mean, sample data mode, and sample data median corresponding to the power supply data set.

Referring to FIG. 2, in one embodiment of the present application, select a target power supply data set from the at least two power supply data sets on the basis of the data statistical parameters respectively corresponding to the at least two power supply data sets, including:

At step S21, count the sample data variance of each power supply data set in at least two power supply data sets respectively, and the sample data variance is the variance of the power supply data supplied by a specified power source over each preset time period.

As an example of the present application, the specified power source is a power source that is determined to power the target device based on demand. For example, the specified power source may be a battery loaded in the target device, or an adapter connected to the target device and capable of powering the target device.

The preset time period refers to the time period determined based on the sampling time corresponding to the power supply data contained in the power supply data set.

For example, the power supply set contains the power supply data with sampling time falling between 10:00-11:00 and the power supply data with sampling time falling between 11:00-12:00. Based on the sampling time of the power supply data, two time periods are determined as 10:00-11:00 and 11:00-12:00.

In the embodiment, in order to determine a power supply data set that can better describe the user's habits of using the target device from at least two power supply data sets, count the sample data variance of each power supply data set in at least two power supply data sets respectively.

In one embodiment, the sample data variance of the power supply data set is counted by the following formula:

$$E = ( ( X 1 - M 1 ) 2 + … + ( Xi - Mi ) 2 ) / n$$

E represents the sample data variance, 1 . . . i represents the number of preset time periods of each day. Mi represents the average proportion of the target power supply data samples corresponding to the same preset time period every day among all power supply data samples contained in the target power supply data set, n represents the preset number of preset time periods of valid power supply samples are met.

It can be understood that in order to avoid having too few power supply data samples within the preset time period, which may affect the accuracy of the sample data variance, the number of the power supply data samples within a single preset time period that does not meet the preset threshold value for the power supply data samples within the preset time period is not contained in the statistical category.

Exemplary, within 24 hours a day, only the 6 hours from 9 am to 11 am and 2 pm to 6 pm meet the number of the valid power supply samples, E=((X10−M10)2+(X11−M11)2+(X15−M15)2+(X16−M16)2+(X17−M16)2+(X18−M18) 2)/6.

At step S22, select a power supply data set with a smallest sample data variance from at least two power supply data sets as a target power supply data set.

As an example of the present application, in order to determine a target power supply data set, the sample data variances corresponding to each power supply data set are compared, so as to select a power supply data set that has the smallest sample data variance from at least two power supply data sets, to obtain the power supply data that better describes the user's habit of using the target device.

It can be understood that the larger the sample data variance, the larger the data fluctuation, the power supply data contained in the power supply data set corresponding to the sample data variance cannot reflect the user's habits of using the target device. On the contrary, the smaller the sample data variance, the smaller the data fluctuation, the power supply data contained in the power supply data set corresponding to the sample data variance can better reflect the user's habits of using the target device, which is more conducive to predicting the power supply mode of the target device based on the power supply data set.

At step S13, determine a power supply mode of the target device according to the target power supply data set.

As an example of the present application, the power supply mode refers to the power supply method used to power the target device. For example, the target device is powered through a battery, or an adapter is connected to the target device to power the target device through a non-battery power supply.

In the embodiment, since the target power supply data set can better reflect the user's habit of using the target device in the historical time corresponding to the current time, in order to better power the target device, the power supply mode of the target device can be determined based on the target power supply data set.

At step S14, use the determined power supply mode to power the target device.

In the embodiment, in order to better power the target device to avoid failure of the target device, after determining the power supply mode of the target device based on the target power supply data set, the determined power supply mode is used to power the target device.

Exemplary, in a specific scenario, the target device is a POS machine, the POS machine is currently powered by batteries. Based on the power supply data contained in the power supply data set for the past 7 consecutive days, it is determined that the POS machine should be powered by a non-battery power supply method after the current point in time. Therefore, the power supply method of the POS machine is updated using non-battery power supply method, to use the non-battery power supply method to power the POS machine.

In one embodiment, after determining the power supply mode of the target device based on the target power supply data set, the power supply mode of the target device is updated based on the determined power supply mode, so that the determined power supply mode can be subsequently used to power the target device.

The device power supply method provided in the present application obtains at least two power supply data sets of the target device, so as to understand the user's usage of the target device at different sampling times through the at least two power supply data sets, then select a target power supply data set from the at least two power supply data sets on the basis of data statistical parameters respectively corresponding to the at least two power supply data sets, to determine the power supply mode of the target device based on the target power supply dataset that can better reflect the user's habits of using the target device, thereby avoiding long-term use of the same power supply mode to power the target device, reducing the power supply safety risk of the target device.

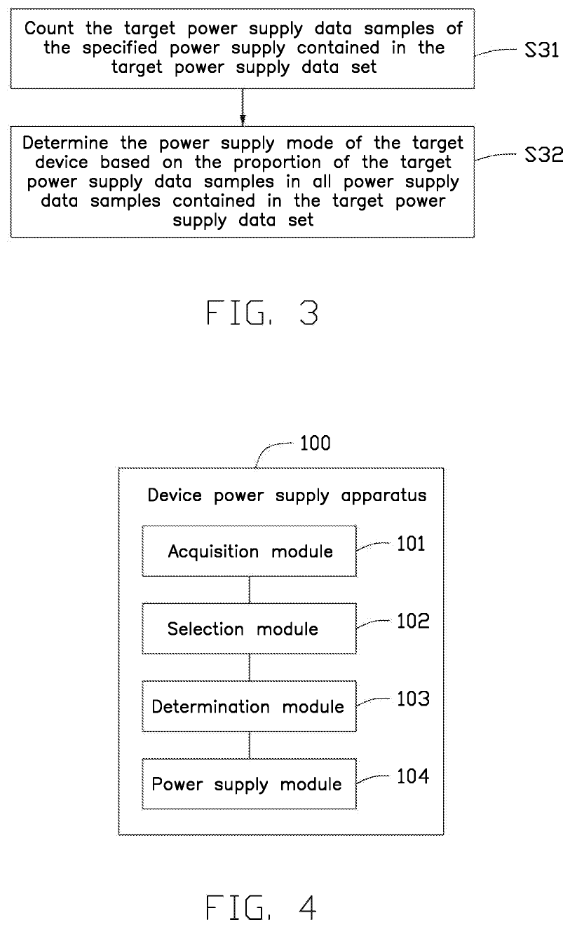

Referring to FIG. 3, in one embodiment of the present application, a specific implementation of determining a power supply mode for a target device according to a target power supply data set includes:

At step S31, count the target power supply data samples of the specified power supply contained in the target power supply data set.

At step S32, determine the power supply mode of the target device based on the proportion of the target power supply data samples in all power supply data samples contained in the target power supply data set.

As an example of the present application, the target power supply data sample refers to the collected data sample to describe the power supply mode of the target device when the target device is powered by the specified power supply. For example, during a period of supplying power to the target device through the battery, the collected data samples can describe the battery powering the target device during that period.

In the embodiment, in order to understand the situation of the way in which power is supplied to the target device during the sampling time of the power supply data contained in the target power supply data set, count the target power supply data samples of the specified power supply contained in the target power supply data set, so as to understand the situation of the way in which power is supplied to the target device during the sampling time of the power supply data contained in the target power supply data set through the proportion of the target power supply data samples in all power supply data samples contained in the target power supply data set, on the basis of the understanding of the way in which power is supplied to the target device, determine the power supply mode for the target device in the following application scenarios.

Exemplary, the specified power supply is an external power supply, count the target power supply data samples when the target device is powered by the external power supply contained in the target power supply data set, so as to understand the situation when the external power supply supplies power to the target device during the sampling time of the power supply data contained in the target power supply data set based on the proportion of the target power supply data samples in all power supply data samples contained in the target power supply data set, for example, understand the number of the collected power supply data samples when using the external power supply to power the target device, to understand the duration that the external power source is powering the target device, thereby providing a reference for the target device after the current moment to power the target device with an external power source or a battery.

In one embodiment of the present application, a specific implementation of determining the power supply mode of the target device based on the proportion of the target power supply data samples in all power supply data samples contained in the target power supply data set includes:

If the proportion of the target power supply data samples in all power supply data samples contained in the target power supply data set is less than a first threshold, the power supply mode of the target device is determined to be a first power supply mode.

If the proportion of the target power supply data samples in all power supply data samples contained in the target power supply data set is less than a second threshold and greater than the first threshold, the power supply mode of the target device is determined to be a second power supply mode.

If the proportion of the target power supply data samples in all power supply data samples contained in the target power supply data set is greater than a second threshold, the power supply mode of the target device is determined to be a second power supply mode.

As an example of the present application, both the first threshold and the second threshold can be pre-set according to actual needs. For example, set the first threshold to 50% and the second threshold to 98%.

The first power supply mode refers to a mode in which the target device is mainly powered by a battery mode. The battery mode refers to a mode in which the target device is powered by a device such as a lithium battery that can store energy so that the target device can operate.

Exemplary, the first power supply mode can be a mobile mode, a mode in which the target device is not connected to the external power source after being fully charged, and the target device is powered for use by the battery.

In some embodiments, in the first power supply mode, the full charge amount/voltage is 100%/4.2V, and the return charge amount/voltage is 85%/4.0V, respectively. The return charge amount/voltage is a charge amount/voltage threshold at which charging is initiated again after a full charge.

It can be understood that in the first power supply mode, in order to avoid catching fire in case of battery failure, the full charge amount can be set according to the actual battery loaded in the target device.

The second power supply mode refers to a mode in which the target device is mainly powered by a non-battery mode. The non-battery mode refers to a mode in which the target device is powered by connecting to the external power source through a charge base in conjunction with a power adapter, so that the target device can operate.

Exemplary, the second power supply mode is a desktop mode, a mode in which the target device is placed in a fixed location and is connected to the external power supply including a charge base and a power adapter, and the target device is powered for use by the charge base based on the power adapter.

In some embodiments, in the second power supply mode, the full charge amount/voltage is 80%/4.0V, and the return charge amount/voltage is 65%/3.9V, respectively.

It can be understood that in the second power supply mode, in order to avoid catching fire in case of battery failure, the full charge amount can be set according to the actual battery loaded in the target device.

The third power supply mode refers to a mode in which the target device is mainly powered by the non-battery mode and the target device is supplemented by the battery mode within a preset duration.

In some embodiments, in the third power supply mode, the full charge amount/voltage is 30%/3.55V, and the return charge amount/voltage is 20%/3.45V, respectively.

It can be understood that in the third power supply mode, in order to avoid catching fire in case of battery failure, the full charge amount can be set according to the actual battery loaded in the target device. For example, the full charge amount is defined as 30%, mainly because 18650 batteries will not catch fire even if they fail at 30% charge. For example, civil aviation regulations require that lithium batteries be transported by air to meet UN38.3 test conditions, including that the battery charge cannot exceed 30%.

In the embodiment, in order to better determine the power supply mode of the target device based on the power supply data that describes past the user's habits of using the target device, after determining the proportion of the target power supply data samples in all power supply data samples contained in the target power supply data set, the determined proportion is compared with the first threshold and the second threshold, in order to obtain a comparison relationship between the proportion and the first threshold and a comparison relationship between the proportion and the second threshold, determine a power supply mode of the target device from the first power supply mode, the second power supply mode, and the third power supply mode based on the obtained comparison relationship between the proportion and the first threshold, and the obtained comparison relationship between the proportion and the second threshold.

In one embodiment of the present application, if a number of all power supply data samples contained in the target power supply data set is less than a third threshold, the power supply mode of the target device is determined to be the first power supply mode.

As an example of the present application, the third threshold may be pre-set according to actual needs, or determined by the number of power supply data samples that may be collected within the remaining standby time of the target device.

It can be understood that when there are few power supply data samples, it is not conducive to analyzing the user's habits of using the target device. Therefore, when the number of all power supply data samples contained in the target power supply data set is less than the third threshold, the power supply mode of the target device is determined as the first power supply mode, so that the user can continue to use the target device and continue to collect power supply data samples during the use of the target device.

In one embodiment of the present application, after using a power supply mode to power the target device, further including:

Detect whether the current time is within a specified time period after a third duration.

If the current time is within the specified time period, return to the step of obtaining the historical power supply data of the target device.

As an example of the present application, the third duration may be pre-set according to actual needs. For example, the third duration is set to 30 minutes.

The specified time period is a time period that is required to trigger a return to perform the step of obtaining the historical power supply data for the target device.

Preferably, the specified time period is a time period in the next day following the time of the day for the target device. For example, if the current time is greater than 0:00 and less than or equal to 0:30 of the next day, it means that it is in the specified time period of the next day.

In the embodiment, in order to avoid that the collected power supply data samples do not clearly show the situation of each day, after the power supply mode is used to power the target device, during a third duration, it is detected whether or not the current time is within a specified time period, so as to return to perform the step of obtaining the historical power supply data of the target device when it is determined that the current time is within the specified time period, and thus determine the power supply mode of the target device within the next day, so as to avoid that the collected power supply data samples do not clearly show the situation of each day.

In one embodiment, if the current time is not within the specified time period, the step of selecting the target power supply data set from the at least two power supply data sets on the basis of data statistical parameters respectively corresponding to the at least two power supply data sets.

In some embodiments, in order to avoid the target device is in operation for a long time, the amount of the collected power supply data is large and can lead to data redundancy, which is not conducive to predicting the power supply mode of the target device, the power supply data prior to a preset time point is deleted by a preset cycle.

Exemplary, the historical power supply data of the target device from 28 days ago is deleted every 24 hours.

In some embodiments, if the target device is detected to be powered on, the historical power supply sample data prior to the preset time point is deleted. Next, the power supply data of the target device is started to be collected.

It can be understood that in the application, the collected power supply data of the target device is stored in a preset storage area.

In some embodiments, in order to better power the target device, when the target device is detected to be turned on, it is detected whether there is a set power supply mode. If there is a set power supply mode, the target device is powered through the set power supply mode.

It can be understood that the serial numbers of the steps in the above described embodiments do not imply the order of execution, and the order of execution of the processes should be determined by their functions and inherent logic without constituting any limitation of the process of implementing the embodiments of the present application.

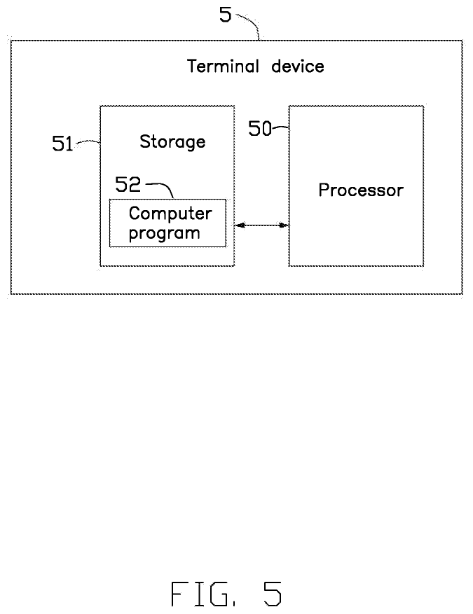

Corresponding to the device power supply method of the above embodiments, FIG. 5 illustrates a block diagram of a device power supply device provided by the embodiments of the present application, and for the sake of illustration, only portions relevant to embodiments of the present application are shown.

Referring to FIG. 4, the device 100 includes:
An acquisition module 101 is used to obtain historical power supply data of a target device, wherein the historical power supply data comprises at least two power supply data sets, and sampling times of power supply data contained in any two power supply data sets are not exactly the same;
A selection module 102 is used to select a target power supply data set from the at least two power supply data sets on the basis of data statistical parameters respectively corresponding to the at least two power supply data sets;
A determination module 103 is used to determine a power supply mode of the target device according to the target power supply data set;
A power supply module 104 is used to use the determined power supply mode to power the target device.

In one embodiment, the acquisition module 101 is further used to obtain a first set of power supply data and a second set of power supply data of the target device, the first set of power supply data contains the historical power supply data of the target device for a first duration before the time of the current day, the second set of power supply data contains the historical power supply data of the target device for each week X in a second duration before the time of the current day, and the time of the day is a week X, and X is any of the values from 1 to 7.

In one embodiment, the selection module 102 is further used to count the sample data variance of each power supply data set in at least two power supply data sets respectively, and the sample data variance is the variance of the power supply data supplied by a specified power source over each preset time period; select a power supply data set with a smallest sample data variance from at least two power supply data sets as a target power supply data set.

In one embodiment, the determination module 103 is further used to count the target power supply data samples of the specified power supply contained in the target power supply data set, determine the power supply mode of the target device based on the proportion of the target power supply data samples in all power supply data samples contained in the target power supply data set.

In one embodiment, the determination module 103 is further used to determine the power supply mode of the target device is a first power supply mode if the proportion of the target power supply data samples in all power supply data samples contained in the target power supply data set is less than a first threshold; determine the power supply mode of the target device is a second power supply mode if the proportion of the target power supply data samples in all power supply data samples contained in the target power supply data set is less than the second threshold and greater than the first threshold; determine the power supply mode of the target device is a third power supply mode if the proportion of the target power supply data samples in all power supply data samples contained in the target power supply data set is greater than the second threshold.

In one embodiment, the determination module 103 is further used to determine the power supply mode of the target device is the first power supply mode if a number of all power supply data samples contained in the target power supply data set is less than a third threshold.

In one embodiment, the acquisition module 101 is further used to detect whether the current time is within a specified time period after a third duration; return to the step of obtaining the historical power supply data of the target device if the current time is within the specified time period.

The embodiment provides a device power supply apparatus for realizing any one of the device power supply methods in the method embodiments, the functions of the various modules can be referred to the corresponding descriptions in the method embodiments, which are similar in terms of their realization principles and technical effects and will not be repeated herein.

FIG. 5 is a schematic diagram of a terminal device according to an embodiment of the present disclosure. As shown in FIG. 5, the terminal device 5 of the embodiment includes: at least one processor 50 (only one processor is shown in FIG. 5), a storage 51, and computer program 52 stored in the storage 51 and runnable on the at least one processor 50, the processor 50 executes the computer program 52 to implement the steps in any of the above device power supply method embodiments.

The terminal device 5 can be computing devices such as POS machines, desktop computers, laptops, handheld computers, and cloud servers. The terminal device may include, but is not limited to, a processor 50 and a storage 51. The person of ordinary skill in the field can understand that FIG. 5 is only an example of the terminal device 5 and does not constitute a limitation on the terminal device 5, it may include more or fewer components than shown, or combinations of certain components, or different components, such as input/output devices, network access devices.

The processor 50 can be a central processing unit (CPU), the processor 50 can also be other general-purpose processors, digital signal processors (DSPs), application specific integrated circuits (ASICs), field programmable gate arrays (FPGAs), or other programmable logic devices, discrete gates, or transistor logic devices discrete hardware components. The general-purpose processor can be a microprocessor or any conventional processor.

The storage 51 can be an internal storage unit of the terminal device 5 in some embodiments, such as the hard disk or the memory of the terminal device 5. The storage 51 can also be an external storage device of the terminal device 5 in other embodiments, such as a plug-in hard disk, a smart media card (SMC), a secure digital (SD) card, a flash card equipped on the terminal device 5. Furthermore, the storage 51 can also include both internal storage units of the terminal device 5 and external storage devices. The storage 51 is used to store an operating system, an application program, a boot loader, data, and other programs, such as program code for a computer program. The storage 51 can also be used to temporarily store data that has been or will be output.

It is to be noted that the contents of the information interaction and execution process between the above devices/units, etc., as they are based on the same idea as the method embodiments of the present application, the specific functions and technical effects brought about by them can be specifically referred to in the section of the method embodiments, and they will not be repeated herein.

The person of ordinary skill in the field can clearly understand that, for the convenience and conciseness of description, only the division of various functional units and modules mentioned above is given as an example. In practical applications, the above functions can be assigned to different functional units and modules as needed, the internal structure of the device can be divided into different functional units or modules to complete all or part of the functions described above. The various functional units and modules in the implementation example can be integrated into one processing unit, or they can exist separately physically, or two or more units can be integrated into one unit. The integrated units mentioned above can be implemented in the form of hardware or software functional units. In addition, the specific names of each functional unit and module are only for the purpose of distinguishing them from each other and are not used to limit the scope of protection of this application. The specific working process of the units and modules in the above system can refer to the corresponding process in the method implementation examples and will not be repeated here.

The embodiments of the present application also provide a terminal device, the terminal device includes at least one processor, a storage, and a computer program stored in the storage and runnable on the at least one processor, when the processor executes the computer program, it implements the steps of any of the above embodiments.

The embodiments of the present application also provide a computer readable storage medium, the computer readable storage medium stores the computer program. When the computer program is executed by the processor, the steps in the above method embodiments can be implemented.

The embodiments of the present application also provide a computer program product, when the computer program product is run on the terminal device, enables the terminal device to implement the steps in the above method embodiments during execution.

If the integrated unit is implemented in the form of a software functional unit and sold or used as an independent product, it can be stored in a computer readable storage medium. Based on this understanding, the present application implements all or part of the processes in the above-mentioned embodiments, which can be completed by instructing the relevant hardware through a computer program. The computer program can be stored in a computer readable storage medium, and when executed by the processor, the steps of the various embodiments of the above-mentioned methods can be implemented. The computer program includes computer program code, which can be in the form of source code, object code, executable files, or some intermediate form. The computer readable medium can at least include: any entity or device capable of carrying computer program code to a device/terminal device, recording medium, computer memory, read only memory (ROM), random access memory (RAM), electrical carrier signals, telecommunications signals, and software distribution medium. For example, USB drives, portable hard drives, disks, or CDs.

In the above embodiments, the descriptions of each embodiment have their own emphasis. For parts that are not detailed or recorded in one embodiment, please refer to the relevant descriptions of other embodiments.

The person of ordinary skill in the field can realize that the units and algorithm steps of each example described in the disclosed embodiments can be implemented in electronic hardware, or a combination of computer software and electronic hardware. Whether these functions are executed in hardware or software depends on the specific application and design constraints of the technical solution. Professional technicians can use different methods to achieve the described functions for each specific application, but such implementation should not be considered beyond the scope of the present application.

In the embodiments provided in the present application, it should be understood that the disclosed devices/terminal devices and methods may be implemented in other ways. For example, the device/terminal device embodiments described above are only illustrative. For example, the division of modules or units is only a logical function division, and there may be other division methods in actual implementation. For example, multiple units or components can be combined or integrated into another system, or some features can be ignored or not executed. At another point, the mutual coupling or direct coupling or communication connection shown or discussed may be an indirect coupling or communication connection through some interface, device or unit, which may be electrical, mechanical or otherwise.

The unit used as a separate component description can be or may not be physically separated, and the component displayed as a unit can be or may not be a physical unit, which can be located in one place or distributed across multiple network units. Some or all units can be selected according to actual needs to achieve the purpose of this embodiment.

The above embodiments are only used to illustrate the technical solution of the present application, and not to limit it; although the present application has been described in detail with reference to the aforementioned embodiments, ordinary technical personnel in this field should understand; it can still modify the technical solutions recorded in the aforementioned embodiments, or equivalently replace some of the technical features; and these modifications or replacements do not separate the essence of the corresponding technical solutions from the spirit and scope of the technical solutions in each embodiment of the present application, and should be included in the scope of protection of the present application.

1. A device power supply method, characterized by comprising:
obtaining historical power supply data of a target device, wherein the historical power supply data comprises at least two power supply data sets, and sampling times of power supply data included in any two power supply data sets are not exactly the same;
selecting a target power supply data set from the at least two power supply data sets on the basis of data statistical parameters respectively corresponding to the at least two power supply data sets;
determining a power supply mode of the target device according to the target power supply data set;
using the determined power supply mode to power the target device.

2. The device power supply method of claim 1, characterized in that the obtaining the historical power supply data of the target device comprises:
obtaining a first set of power supply data and a second set of power supply data of the target device, wherein the first set of power supply data comprises the historical power supply data of the target device for a first duration before a time of a current day, the second set of power supply data comprises the historical power supply data of the target device for each week X in a second duration before the time of the current day, and the time of the current day is the week X, and X is any of values from 1 to 7.

3. The device power supply method of claim 1, characterized in that the selecting a target power supply data set from the at least two power supply data sets on the basis of data statistical parameters respectively corresponding to the at least two power supply data sets comprises:
counting a sample data variance of each power supply data set in at least two power supply data sets respectively, and the sample data variance is a variance of the power supply data supplied by a specified power source over each preset time period;
selecting a power supply data set with a smallest sample data variance from the at least two power supply data sets as a target power supply data set.

4. The device power supply method of claim 1, characterized in that the determining a power supply mode of the target device according to the target power supply data set comprises:
counting target power supply data samples of the specified power supply contained in the target power supply data set;
determining the power supply mode of the target device based on a proportion of the target power supply data samples in all power supply data samples contained in the target power supply data set.

5. The device power supply method of claim 4, characterized in that the determining the power supply mode of the target device based on the proportion of the target power supply data samples in all power supply data samples contained in the target power supply data set comprises:
determining the power supply mode of the target device is a first power supply mode if the proportion of the target power supply data samples in all power supply data samples contained in the target power supply data set is less than a first threshold;
determining the power supply mode of the target device is a second power supply mode if the proportion of the target power supply data samples in all power supply data samples contained in the target power supply data set is less than a second threshold and greater than the first threshold;
determining the power supply mode of the target device is a third power supply mode if the proportion of the target power supply data samples in all power supply data samples contained in the target power supply data set is greater than the second threshold.

6. The device power supply method of claim 5, characterized in that the device power supply method further comprises:
determining the power supply mode of the target device is the first power supply mode if a number of all power supply data samples contained in the target power supply data set is less than a third threshold.

7. The device power supply method of claim 1, characterized in that after using a determined power supply mode to power the target device, further comprises:
detecting whether current time is within a specified time period after a third duration;
returning to the step of obtaining the historical power supply data of the target device if the current time is within the specified time period.

8. A device power supply apparatus, characterized by comprising:
an acquisition module configured for obtaining historical power supply data of a target device, wherein the historical power supply data comprises at least two power supply data sets, and sampling times of power supply data included in any two power supply data sets are not exactly the same;
a selection module configured for selecting a target power supply data set from the at least two power supply data sets on the basis of data statistical parameters respectively corresponding to the at least two power supply data sets;
a determination module configured for determining a power supply mode of the target device according to the target power supply data set;
a power supply module configured for using the determined power supply mode to power the target device.

9. A terminal device, characterized by comprising:
a storage,
a processor, and
computer program stored in the storage and runnable on the processor; wherein when the processor executes the computer program, the terminal device is enabled to implement the device power supply method according to claim 1.

10. A computer readable storage medium, characterized in that, the computer readable storage medium stores computer program, the computer program is executed by a processor and configured to implement the device power supply method according to claim 1.
